(19) United States
(12) Patent Application Publication
(10) Pub. No.: US 2026/0261281 A1
(43) Pub. Date: Sep. 3, 2026

(54) METHOD AND APPARATUS FOR CO-SCHEDULING SENSING AND RANGING IN ULTRA-WIDEBAND COMMUNICATION

(71) Applicant: Samsung Electronics Co., Ltd., Gyeonggi-do (KR)

(72) Inventors: Aniruddh Rao KABBINALE, Bangalore (IN); Ankur BANSAL, Bangalore (IN); Karthik Srinivasa GOPALAN, Bangalore (IN)

(21) Appl. No.: 18/993,703

(22) PCT Filed: Jul. 7, 2023
(86) PCT No.: PCT/KR2023/009698

§ 371 Date: Jan. 13, 2025

(30) Foreign Application Priority Data
Jul. 11, 2022 (IN) 202241039710
Jun. 5, 2023 (IN) 202241039710

(51) Int. Cl. H04B 1/7163

(52) U.S. Cl. CPC H04B 1/71632; H04B 1/71635; H04B 2201/71634

(57) ABSTRACT

Embodiments are directed to a method for scheduling sensing and ranging in an ultra-wideband (UWB) system. The method includes determining a block comprising a plurality of rounds, wherein each of the plurality of rounds comprises a plurality of slots and determining whether sensing and ranging are to be scheduled in a single session or multiple sessions. Further, the method includes scheduling the sensing and the ranging by interleaving the ranging and the sensing in the plurality of slots of at least one round of the plurality of rounds in the determined block, in response to determining that the sensing and the ranging are to be scheduled in the single session, and providing the ranging and the sensing in the plurality of rounds of the determined block, in response to determining that the sensing and the ranging are to be scheduled in the multiple sessions.

### TECHNICAL FIELD

The present disclosure relates to ultra-wideband (UWB) system, and more specifically related to a method and apparatus for co-scheduling sensing and ranging in UWB.

### BACKGROUND ART

In general, existing techniques in Ultra-Wideband (UWB) includes time structure defined for scheduling ranging. The time structure for scheduling the ranging comprises interval based mode and block based mode. A set of messages have been defined to exchange or configure ranging schedule between a controller and multiple controlees.

However, scheduling of sensing in the UWB is not yet standardized. Also, it is to be noted that the sensing also has requirements of a schedule. There would be a sensing controller, sensing controlees and message exchange between the sensing controller and the sensing controlees which needs to be defined. There is no existing method defined for co-scheduling both the ranging and the sensing within a group of a controller and the controlees that can perform both the sensing and the ranging activities. Thus, it is desired to at least provide a mechanism for auto focus that is devoid of the above issues.

### DISCLOSURE OF INVENTION

### Solution to Problem

The principal object of the embodiments herein is to a method and UWB system for co-scheduling sensing and ranging. The proposed method includes defining method for co-scheduling both the ranging and the sensing within a group of a controller and the controlees that can perform both the sensing and the ranging activities.

Accordingly, embodiments herein disclose a method for scheduling sensing and ranging in an ultra-wideband (UWB) system. The method includes determining a block comprising a plurality of rounds, wherein each of the plurality of rounds comprises a plurality of slots and determining whether sensing and ranging are to be scheduled in a single session or multiple sessions. The method also includes scheduling the sensing and the ranging by interleaving the ranging and the sensing in the plurality of slots of at least one round of the plurality of rounds in the determined block, in response to determining that the sensing and the ranging are to be scheduled in the single session, and providing the ranging and the sensing in the plurality of rounds of the determined block, in response to determining that the sensing and the ranging are to be scheduled in the multiple sessions.

In an embodiment, the sensing round is a period for completing one entire sensing cycle involving a plurality of devices of the UWB system participating in a sensing exchange and wherein the ranging round is a period for completing one range-measurement cycle involving the plurality of devices of the UWB system participating in a ranging exchange.

In an embodiment, scheduling the sensing and the ranging by interleaving the ranging and the sensing in the plurality of slots of the at least one round of the plurality of rounds in the determined block, in response to determining that the sensing and the ranging is to be scheduled in the single session includes determining a configuration of the determined block for scheduling the sensing and the ranging and determining a control message comprising a ranging control message (RCM) for at least one ranging slot and a sensing control message (SCM) for at least one sensing slot, wherein a duration of the at least one ranging slot and the at least one sensing slot may be different. The method also includes scheduling the sensing and the ranging by interleaving the ranging and the sensing in the plurality of slots of the at least one round in the determined block, wherein the at least one round is a session of at least one of the ranging and the sensing.

In an embodiment, the at least one round is at least one of: a one-to-one ranging session a one-to-one sensing session, a one-to-many ranging and/or sensing session a many-to-many ranging and/or sensing session.

In an embodiment, a schedule for the determined block is provided at a beginning of the at least one round and wherein the schedule for the determined block comprises at least one of a ranging schedule and a sensing schedule.

In an embodiment, scheduling the sensing and the ranging by providing the ranging and the sensing in the determined block, in response to determining that the sensing and the ranging are to be scheduled in the multiple sessions includes determining a configuration of the determined block using Advanced Ranging Control (ARC) IE for scheduling the ranging, wherein the configuration of the determined block is updated using a Ranging Block Update (RBU) IE. The method includes determining a configuration of the determined block for scheduling and configuring sensing, using the SCM and determining a control message comprising a plurality of IEs comprising a flag for indicating the at least one round and the at least one sensing round. The method also includes providing the RCM for the at least one round and the SCM for the at least one sensing round in the control message; and scheduling the sensing and the ranging by consecutively providing the at least one round and the at least one sensing round in the determined block, wherein the scheduling the at least one round is managed using RDM IE and the at least one sensing round is managed using SCM.

In an embodiment, the configuration of the determined block for scheduling the sensing and the ranging comprises a block duration, a round duration, a slot duration, round indices, sensing round indices.

In an embodiment, the control message is used for at least one of configure, control and schedule the at least one of sensing and ranging.

In an embodiment, the at least one round is for at least one of: a one-to-one ranging session, one-to-many ranging session and many-to-many ranging session and wherein the at least one sensing round is for at least one of: a one-to-one sensing session, a one-to-many sensing session and a many-to-many sensing session.

Accordingly, embodiments herein disclose an ultra-wideband (UWB) system for scheduling sensing and ranging. In the disclosure, the method and apparatus for the UWB system (100) may be implemented within the electronic device. The electronic device includes a plurality of controller devices which control a plurality of controlee devices. The electronic device includes a memory, a processor, a communicator and a scheduling controller. The scheduling controller is configured to determine a block comprising a plurality of rounds, wherein each of the plurality of rounds comprises a plurality of slots and determine whether the sensing and the ranging are to be scheduled in a single session or multiple sessions. The scheduling controller is also configured to schedule the sensing and the ranging by interleaving the ranging and the sensing in the plurality of slots of at least one round of the plurality of rounds in the determined block, in response to determining that the sensing and the ranging are to be scheduled in the single session, and providing the ranging and the sensing in the plurality of rounds of the determined block, in response to determining that the sensing and the ranging are to be scheduled in the multiple sessions.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein, and the embodiments herein include all such modifications.

### BRIEF DESCRIPTION OF DRAWINGS

This disclosure is illustrated in the accompanying drawings, throughout which like reference letters indicate corresponding parts in the various figures. The embodiments herein will be better understood from the following description with reference to the drawings, in which:

FIG. 1 is a block diagram of an UWB system for co-scheduling sensing and ranging, according to an embodiment as disclosed herein;

FIG. 2 is a flow chart illustrating a method for co-scheduling the sensing and the ranging by the UWB system, according to an embodiment as disclosed herein;

FIG. 3 is an example illustrating a timing structure for co-scheduling the sensing and the ranging in a single session, according to an embodiment as disclosed herein;

FIG. 4 is an example illustrating a timing structure for co-scheduling the sensing and the ranging in multiple session, according to an embodiment as disclosed herein; and

FIG. 5 is an example Illustration of block, round and slot with sensing and ranging performed in multiple rounds, according to an embodiment as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the invention

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Accordingly, embodiments herein disclose a method for scheduling sensing and ranging in an ultra-wideband (UWB) system. The method includes determining a block comprising a plurality of rounds, wherein each of the plurality of rounds comprises a plurality of slots and determining whether the sensing and the ranging are to be scheduled in a single session or multiple sessions. The method also includes scheduling the sensing and the ranging by interleaving the ranging and the sensing in the plurality of slots of at least one round of the plurality of rounds in the determined block, in response to determining that the sensing and the ranging is to be scheduled in the single session, and providing the ranging and the sensing in the plurality of rounds of the determined block, in response to determining that the sensing and the ranging are to be scheduled in the multiple sessions.

Accordingly, embodiments herein disclose an ultra-wideband (UWB) system for scheduling sensing and ranging. In the disclosure, the method and apparatus for the UWB system (100) may be implemented within the electronic device. The electronic device includes a plurality of controller devices which control a plurality of controlee devices. The electronic device includes a memory, a processor, a communicator and a scheduling controller. The scheduling controller is configured to determine a block comprising a plurality of rounds, wherein each of the plurality of rounds comprises a plurality of slots and determine whether the sensing and the ranging are to be scheduled in a single session or multiple sessions. The scheduling controller is also configured to schedule the sensing and the ranging by interleaving the ranging and the sensing in the plurality of slots of at least one round of the plurality of rounds in the determined block, in response to determining that the sensing and the ranging are to be scheduled in the single session, and providing the ranging and the sensing in the plurality of rounds of the determined block, in response to determining that the sensing and the ranging are to be scheduled in the multiple sessions.

Conventional methods and systems include time structure is defined for scheduling ranging on interval based mode and block based mode. A set of messages defined to exchange or configure ranging schedule between controller and its controlees. The scheduling of UWB sensing is not yet standardized. There would be a sensing controller, sensing controlees and message exchange between them needs to be defined. There is no existing method defined for co-scheduling ranging and sensing within the group of a controller and its controlees devices that can do both sensing and ranging activities.

Unlike to the conventional methods and systems, the proposed method both the ranging and the sensing are co-scheduled within the same block in a same session or multiple sessions.

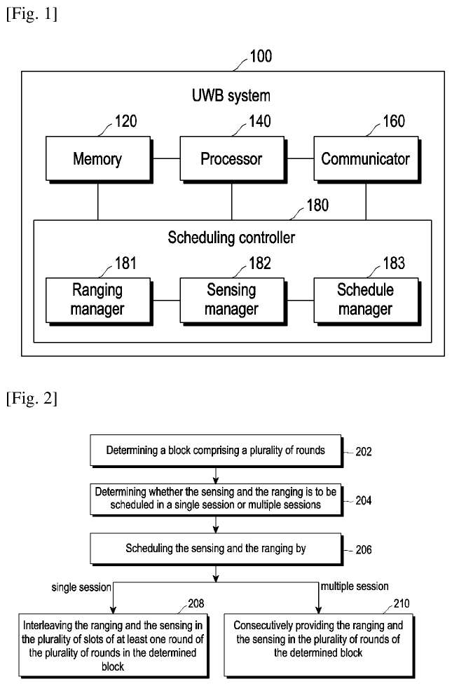

Referring now to the drawings, and more particularly to FIGS. 1 through 5, where similar reference characters denote corresponding features consistently throughout the figures, there are shown preferred embodiments.

FIG. 1 is a block diagram of an UWB system (100) for co-scheduling sensing and ranging, according to an embodiment as disclosed herein. The UWB system (100) includes a memory (120), a processor (140), a communicator (160), and a sensing controller (180). The sensing controller (180) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductors.

The UWB system (100) that is illustrated in FIG. 1 may be implemented as an electronic device. In the disclosure, the method and apparatus for the UWB system (100) may be implemented within the electronic device.

The memory (120) is configured to store instructions to be executed by the processor (140). The memory (120) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (120) may, in some examples, be considered a non-transitory storage medium. The term “non-transitory” may indicate that the storage medium is not embodied in a carrier wave or a propagated signal. However, the term “non-transitory” should not be interpreted that the memory (120) is non-movable. In some examples, the memory (120) can be configured to store larger amounts of information. In certain examples, a non-transitory storage medium may store data that can, over time, change (e.g., in Random Access Memory (RAM) or cache).

The processor (140) communicates with the memory (120), the communicator (160) and the contact pressure management controller (180). The processor (140) is configured to execute instructions stored in the memory (120) and to perform various processes. The processor may include one or a plurality of processors, may be a general purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The communicator (160) includes an electronic circuit specific to a standard that enables wired or wireless communication. The communicator (160) is configured to communicate internally between internal hardware components of the wearable device (100) and with external devices via one or more networks.

In an embodiment, the sensing controller (180) includes a ranging manager (181), a sensing manager (182) and a schedule manager (183).

The ranging manager (181) is configured to determine a block which includes a plurality of rounds. Each of the plurality of rounds includes a plurality of slots. A schedule for the determined block is provided at a beginning of the at least one round and wherein the schedule for the determined block includes at least one of a ranging schedule and a sensing schedule.

The sensing manager (182) is configured to determine sensing related parameters and sensing rounds. The sensing round is a period for completing one entire sensing cycle involving a plurality of devices of the UWB system (100) participating in a sensing exchange.

The schedule manager (183) is configured to determine whether the sensing and the ranging are to be scheduled in a single session or multiple sessions and schedule the sensing and the ranging by interleaving the ranging and the sensing in the plurality of slots of at least one round of the plurality of rounds in the determined block, on determining that the sensing and the ranging is to be scheduled in the single session, and providing the ranging and the sensing in the plurality of rounds of the determined block, in response to determining that the sensing and the ranging are to be scheduled in the multiple sessions. The at least one round is a period for completing one range-measurement cycle involving the plurality of devices of the UWB system (100) participating in a ranging exchange.

The schedule manager (183) is configured to schedule the sensing and the ranging by interleaving the ranging and the sensing in the plurality of slots of the at least one round of the plurality of rounds in the determined block, on determining that the sensing and the ranging are to be scheduled in the single session includes the schedule manager (183) is configured to determine a configuration of the determined block for scheduling the sensing and the ranging and determine a control message comprising a ranging control message (RCM) for ranging slot and a sensing control message (SCM) for sensing slot. Duration of the ranging slot and the sensing slot is different. Here, the at least one round is at least one of: a one-to-one ranging session, a one-to-one sensing session, a one-to-many ranging and/or sensing session a many-to-many ranging and/or sensing session.

The schedule manager (183) is configured to schedule the sensing and the ranging by providing the ranging and the sensing in the determined block, on determining that the sensing and the ranging are to be scheduled in the multiple sessions includes the schedule manager (183) is configured to determine a configuration of the determined block using Advanced Ranging Control (ARC) IE for scheduling the sensing and the ranging and determine a control message comprising a plurality of IEs comprising a flag for indicating the at least one round and the at least one sensing round. The configuration of the determined block is updated using a Ranging Block Update (RBU) IE. Further, the schedule manager (183) is configured to determine a configuration of the determined block for scheduling and configuring sensing, using the SCM. Further, the schedule manager (183) is configured to provide a ranging control message (RCM) for the at least one round and the SCM for the at least one sensing round in the control message and schedule the sensing and the ranging by consecutively providing the at least one round and the at least one sensing round in the determined block. The scheduling the at least one round is managed using RDM IE and the at least one sensing round is managed using SCM. The configuration of the determined block for scheduling the sensing and the ranging comprises block duration, a round duration, slot duration, round indices, sensing round indices. The at least one round is for at least one of: a one-to-one ranging session, one-to-many ranging session and many-to-many ranging session and the at least one sensing round is for at least one of: a one-to-one sensing session, a one-to-many sensing session and a many-to-many sensing session.

At least one of the plurality of modules/components of the sensing controller (180) may be implemented through an AI model. A function associated with the AI model may be performed through memory (120) and the processor (140). The one or a plurality of processors controls the processing of the input data in accordance with a predefined operating rule or the AI model stored in the non-volatile memory and the volatile memory. The predefined operating rule or artificial intelligence model is provided through training or learning.

Here, being provided through learning means that, by applying a learning process to a plurality of learning data, a predefined operating rule or AI model of a desired characteristic is made. The learning may be performed in a device itself in which AI according to an embodiment is performed, and/or may be implemented through a separate server/system.

The AI model may consist of a plurality of neural network layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning process is a method for training a predetermined target device (for example, a robot) using a plurality of learning data to cause, allow, or control the target device to make a determination or prediction. Examples of learning processes include, but are not limited to, supervised learning, unsupervised learning, semi-supervised learning, or reinforcement learning.

Although the FIG. 1 shows various hardware components of the UWB system (100) but it is to be understood that other embodiments are not limited thereon. In other embodiments, the UWB system (100) may include less or more number of components. Further, the labels or names of the components are used only for illustrative purpose and do not limit the scope of the invention. One or more components can be combined together to perform the same or substantially similar function to manage the contact pressure in the UWB system (100).

FIG. 2 is a flow chart illustrating a method for co-scheduling the sensing and the ranging by the UWB system (100), according to an embodiment as disclosed herein.

Referring to the FIG. 2, at step 202 the method includes the UWB system (100) determining the block which includes the plurality of rounds. For example, in the UWB system (100) described in the FIG. 1, the scheduling controller (180) is configured to determine the block which includes the plurality of rounds.

At step 204, the method includes the UWB system (100) determining whether the sensing and the ranging are to be scheduled in the single session or the multiple sessions. For example, in the UWB system (100) described in the FIG. 1, the scheduling controller (180) is configured to determine whether the sensing and the ranging are to be scheduled in the single session or the multiple sessions.

At step 206, the method includes the UWB system (100) scheduling the sensing and the ranging by interleaving the ranging and the sensing in the plurality of slots of at least one round of the plurality of rounds in the determined block, on determining that the sensing and the ranging are to be scheduled in the single session (step 208) and providing the ranging and the sensing in the plurality of rounds of the determined block, on determining that the sensing and the ranging are to be scheduled in the multiple sessions (210). For example, in the UWB system (100) described in the FIG. 1, the scheduling controller (180) is configured to schedule the sensing and the ranging by interleaving the ranging and the sensing in the plurality of slots of at least one round of the plurality of rounds in the determined block, on determining that the sensing and the ranging are to be scheduled in the single session (step 208) and providing the ranging and the sensing in the plurality of rounds of the determined block, on determining that the sensing and the ranging are to be scheduled in the multiple sessions (210).

The various actions, acts, blocks, steps, or the like in the flow diagram (200) may be performed in the order presented, in a different order or simultaneously. Further, in some embodiments, some of the actions, acts, blocks, steps, or the like may be omitted, added, modified, skipped, or the like without departing from the scope of the invention.

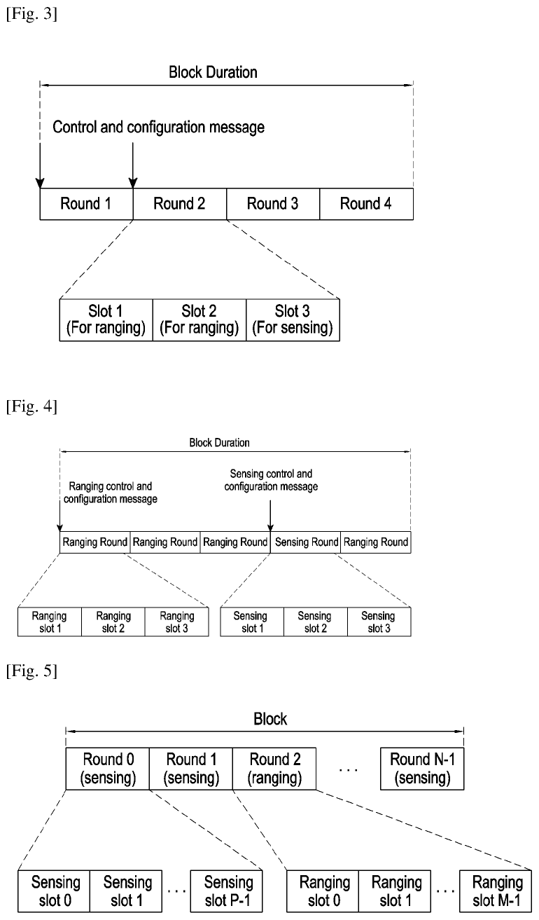

FIG. 3 is an example illustrating a timing structure for co-scheduling the sensing and the ranging in a single session, according to an embodiment as disclosed herein.

Referring to the FIG. 3, the timing structure for co-scheduling the sensing and the ranging in the single session is provided. Here, the timing structure includes the blocks, the rounds and the slots. Each Block is made of building units called rounds; each round is further made of building units called slots. Each round may be of different size and different time duration from other rounds and each slot may be of different size and different time duration from other slots.

Each round may be for a session of a one-to-one ranging or sensing session, a one-to-many ranging and/or sensing session, a many-to-many ranging and/or sensing session. Each round is made up of building units called slots. The slots may be sensing slots or ranging slots. In the FIG. 3, slot 1 and slot 2 are ranging slots and slot 3 is sensing slot. The schedule for the block is shared at the beginning of the round and the schedule is a combination of ranging schedule and/or sensing schedule.

Further, control and configuration message for co-scheduling the sensing and the ranging in the single session is defined. IEs are defined to share initial schedule and updates to the schedule which is already shared. It must be noted that the sensing slot and the ranging slot durations may be different. The control and the configuration messages are provided in table 1 below:

TABLE 1
Control and Configuration message

| | | | |
|---|---|---|---|
| Initial schedule | Schedule | Device schedule | Other Control and |
| IE | update IE | management IE | Configuration |
| | | | parameters |

TABLE 2
Initial Schedule IE

| | | | | | |
|---|---|---|---|---|---|
| Block | Round | Ranging | Sensing | Session | Other |
| duration | duration | slot | slot | ID | Schedule |
| | | duration | duration | | parameters |

TABLE 3
Schedule Update IE

| | | | | | | |
|---|---|---|---|---|---|---|
| Relative | Updated | Updated | Updated | Updated | Session | Updates |
| block | Block | Round | Ranging | Sensing | ID | for Other |
| index | duration | Duration | Slot | Slot | | Sensing |
| | | | duration | duration | | control |
| | | | | | | parameters |

TABLE 4
Device Schedule Management IE

| | |
|---|---|
| Number of Devices | List of Device schedule IE |

TABLE 5
Device Schedule IE

| | | |
|---|---|---|
| Address of Device | Slot Index | Usage (Ranging or Sensing) |

Here, both the RCM and the SCM are together in one message for co-scheduling the sensing and the ranging in the single session.

FIG. 4 is an example illustrating a timing structure for co-scheduling the sensing and the ranging in multiple sessions, according to an embodiment as disclosed herein.

Referring to the FIG. 4, the timing structure for co-scheduling the sensing and the ranging in multiple sessions is provided. Here, a flag is defined and the flag is transmitted at the beginning of the round to indicate if it is a ranging round or a sensing round. Each ranging round may be for a one-to-one ranging or one-to-many ranging session or many-to-many sensing session. Each ranging round is made of building units called ranging slots. Each sensing round may be for a one-to-one sensing session or a one-to-many sensing session or a many-to-many sensing session. Each sensing round is made of building units called sensing slots.

The sensing slot is a time duration in which sensing activity happens. For sensing, a sensing control and configuration message (SCM) is defined and provided in table. 6, which is used to do control and configuration of sensing and is transmitted at the beginning of sensing round. The IEs are defined to exchange initial schedule and updates to the schedule. The sensing slot and the ranging slot durations may be different.

TABLE 6
Sensing Control and Configuration message

| | | | |
|---|---|---|---|
| Initial | Schedule | Device | Other Control and |
| schedule IE | update IE | schedule | Configuration |
| | | management IE | parameters |

TABLE 7
Sensing Initial Schedule IE

| | | | | | |
|---|---|---|---|---|---|
| Round | Sensing | Sensing | Sensing | Session | Other |
| usage | block | round | slot | ID | Sensing |
| | duration | duration | duration | | Schedule |
| | | | | | parameters |
| Ranging or | | | | | |
| Sensing | | | | | |

TABLE 8
Sensing Schedule Update IE

| | | | | | |
|---|---|---|---|---|---|
| Relative | Updated | Updated | Updated | Session ID | Updates for |
| block | Sensing | Sensing | Sensing slot | | Other Sensing |
| index | Block | Round | duration | | control |
| | duration | Duration | | | parameters |

TABLE 9
Sensing Device Schedule Management IE

| | |
|---|---|
| Number of Devices | List of Device schedule IE |

TABLE 10
Sensing Device Schedule IE

| | |
|---|---|
| Address of Device | Slot Index |

Here, the block is made of the ranging rounds and the sensing rounds. The round would be a session of the ranging or the sensing only. The ranging round is made of the ranging slots and the sensing rounds made of the sensing slots where the sensing transmission happens. The proposed timing structure uses the RCM with the ARC IE, the RBU IE and the RDM IE to configure the ranging. Here, the sensing control message (SCM) is defined with the IEs to configure and update the sensing sessions. A single control message can be used with a flag to convey if the round is for the ranging or the sensing.

FIG. 5 is an example Illustration of block, round and slot with sensing and ranging performed in multiple rounds, according to an embodiment as disclosed herein.

Referring to the FIG. 5, the controller may perform both the ranging and the sensing activities with the controlees by using the block and the round structure. Here, each block includes a whole number of rounds, where a round is a period of sufficient duration to complete one entire sensing cycle involving the set of SC-ERDEVs participating in the sensing exchange or a period of sufficient duration to complete one entire range-measurement cycle involving the set of ERDEVs participating in ranging exchange. Each round, based on whether the round is a sensing round or a round is further sub-divided into an integer number of sensing slots or ranging slots respectively. In the FIG. 5, the block is divided into N rounds which may cater to either sensing or ranging activity. Each sensing round consists of P sensing slots. Each round consists of M ranging slots. The sensing slot and the ranging slot duration may be different from each other. The slot duration and the number of slots making up a round can be changed between rounds. A controller sending an RCM with the modified configuration whenever a change is required can achieve the sensing and ranging co-scheduling.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1-17. (canceled)

18. A method by a first ultra-wideband (UWB) device for scheduling sensing and ranging in a UWB system, the method comprising:
determining a block including a plurality of rounds, wherein each of the plurality of rounds includes a plurality of slots;
determining that sensing and the ranging are to be scheduled in a session; and
transmitting, to at least one second UWB device, configuration information for scheduling the sensing and the ranging in the session, wherein the configuration information includes ranging control information and sensing control information.

19. The method of claim 18, wherein a round of the plurality of rounds includes a sensing round, a ranging round, or a combination of the sensing round and the ranging round.

20. The method of claim 18, wherein the configuration information indicates that the sensing and the ranging are scheduled by interleaving the ranging and the sensing in the plurality of slots of at least one round in the determined block, and
wherein the plurality of slots include at least one sensing slot and at least one ranging slot.

21. The method of claim 20, wherein the at least one round includes at least one of:
a one-to-one ranging session,
a one-to-one sensing session,
a one-to-many ranging or sensing session,
a one-to-many ranging and sensing session,
a many-to-many ranging or sensing session or
a many-to-many ranging and sensing session.

22. The method of claim 18, wherein the configuration information is provided at a beginning of a sensing round in the plurality of rounds.

23. The method of claim 18, further comprising:
determining a first configuration of the determined block using an advanced ranging control (ARC) information element (IE) for scheduling the ranging, wherein the first configuration of the determined block is updated using a ranging block update (RBU) IE;
determining a second configuration of the determined block for scheduling and configuring the sensing, using a sensing control message (SCM);
determining a control message including a plurality of IEs, wherein the plurality of IEs include a flag for indicating at least one round and at least one sensing round;
providing a ranging control message (RCM) for the at least one round and the SCM for the at least one sensing round in the control message; and
scheduling the sensing and the ranging by consecutively providing the at least one round and the at least one sensing round in the determined block,
wherein scheduling the at least one round is managed using a ranging data message (RDM) IE and scheduling the at least one sensing round is managed using the SCM.

24. The method of claim 23, wherein the control message is used for at least one of configuring, controlling, or scheduling at least one of the sensing or the ranging.

25. The method of claim 23, wherein each of the second configuration of the determined block for scheduling and configuring the sensing and the first configuration of the determined block for scheduling the ranging includes a block duration, a round duration, a slot duration, round indices, and sensing round indices.

26. The method of claim 23, wherein the at least one round is for at least one of:
a one-to-one ranging session,
a one-to-many ranging session, or
a many-to-many ranging session, and
wherein the at least one sensing round is for at least one of:
a one-to-one sensing session,
a one-to-many sensing session, or
a many-to-many sensing session.

27. The method of claim 18, wherein the sensing round is a period for completing a sensing cycle involving a plurality of devices of the UWB system participating in a sensing exchange, and
wherein the ranging round is a period for completing a range-measurement cycle involving the plurality of devices of the UWB system participating in a ranging exchange.

28. The method of claim 18, wherein different sensing slots in the plurality of rounds are scheduled to different UWB devices.

29. A first ultra-wideband (UWB) device for scheduling sensing and ranging in a UWB system, the first UWB device comprising:
a communicator; and
a processor coupled to the communicator and configured to:
determine a block including a plurality of rounds, wherein each of the plurality of rounds includes a plurality of slots,
determine that sensing and the ranging are to be scheduled in a session, and
transmit, to at least one second UWB device, configuration information for scheduling the sensing and the ranging in the session, wherein the configuration information includes ranging control information and sensing control information.

30. The first UWB device of claim 29, wherein a round of the plurality of rounds includes a sensing round, a ranging round, or a combination of the sensing round and the ranging round.

31. The first UWB device of claim 29, wherein the configuration information indicates that the sensing and the ranging are scheduled by interleaving the ranging and the sensing in the plurality of slots of at least one round in the determined block, and
wherein the plurality of slots include at least one sensing slot and at least one ranging slot.

32. The first UWB device of claim 31, wherein the at least one includes is at least one of:
a one-to-one ranging session,
a one-to-one sensing session,
a one-to-many ranging or sensing session,
a one-to-many ranging and sensing session,
a many-to-many ranging or sensing session, or
a many-to-many ranging and sensing session.

33. The first UWB device of claim 29, wherein the configuration information is provided at a beginning of a sensing round in the plurality of rounds.

34. The first UWB device of claim 29, wherein the processor is further configured to:
determine a first configuration of the determined block using an advanced ranging control (ARC) information element (IE) for scheduling the ranging, wherein the first configuration of the determined block is updated using a ranging block update (RBU) IE,
determine a second configuration of the determined block for scheduling and configuring the sensing, using a sensing control message (SCM),
determine a control message including a plurality of IEs, wherein the plurality of IEs include a flag for indicating at least one round and at least one sensing round,
provide a ranging control message (RCM) for the at least one round and the SCM for the at least one sensing round in the control message, and
schedule the sensing and the ranging by consecutively providing the at least one round and the at least one sensing round in the determined block,
wherein scheduling the at least one round is managed using a ranging data message (RDM) IE and scheduling the at least one sensing round is managed using the SCM.

35. The first UWB device of claim 34, wherein the control message is used for at least one of configuring, controlling, or scheduling at least one of the sensing or the ranging, and
wherein each of the second configuration of the determined block for scheduling and configuring the sensing and the first configuration of the determined block for scheduling the ranging includes a block duration, a round duration, a slot duration, round indices, and sensing round indices.

36. The first UWB device of claim 29, wherein the sensing round is a period for completing a sensing cycle involving a plurality of devices of the UWB system participating in a sensing exchange, and
wherein the ranging round is a period for completing a range-measurement cycle involving the plurality of devices of the UWB system participating in a ranging exchange.

37. The first UWB device of claim 29, wherein different sensing slots in the plurality of rounds are scheduled to different UWB devices.
